(19) United States
(12) Patent Application Publication
(10) Pub. No.: US 2010/0314193 A1
(43) Pub. Date: Dec. 16, 2010

(54) MEMBRANE STIFFENING THROUGH RIBBING FOR ENGINE SOUND TRANSMISSION DEVICE

(75) Inventor: Jasris Jasnie, Kalamazoo, MI (US)

Correspondence Address: Mann+Hummel GMBH;Department VR-P, Hindenburgstr. 45, Ludwigsburg, 71638, DE

(73) Assignee: MANN+HUMMEL GMBH, Ludwigsburg (DE)

(21) Appl. No.: 12/483,496

(22) Filed: Jun. 12, 2009

(51) Int. Cl. G10K 11/00

(52) U.S. Cl. 181/175

(57) ABSTRACT

Disclosed is an engine sound transmission device for a motor vehicle. The device includes a membrane that is selectively tuned by the addition of countermeasures provided on the membrane to selectively stiffen portions of the membrane so to attenuate undesired frequency components. The membrane countermeasures result in improved tuning of the engine sound transmitted to the passenger compartment while providing improved material savings when compared to other tuning options including a quarter wave tuner or a side branch resonator.

### TECHNICAL FIELD

The invention relates to sound transmission devices for conducting engine sound towards or into the passenger compartment of a motor vehicle and, more particularly, to apparatus and methods for attenuating undesired frequency components of the transmitted sound.

### BACKGROUND OF THE INVENTION

Devices configured to conduct engine sound from the engine compartment of a motor vehicle into the passenger compartment are known. In one known configuration a sound transmission device includes a flexible tube or pipe in which one end is connected into the air intake tract of the engine and an opposing end positioned near or extending through the firewall into the passenger compartment.

As a drive unit, modern motor vehicles have internal combustion engines that operate very smoothly so that the engine operating sound may be barely audible within the interior of the motor vehicle. The operating sound of the internal combustion engine may be obscured by other secondary noises such as road noises, vehicle HVAC systems, etc.

Under certain circumstances it can be desirable to transmit the operating sound of the internal combustion engine to the interior of the motor vehicle. Engine sound may be channeled through the sound transmission device to provide a “sporty” engine sound experience to the driver and passengers. In some cases the sound output of the sound transmission device is relatively low in volume with the result that it is sometimes desirable to extend the sound transmission device tube into the vehicle interior from the engine compartment to thereby improve the transmitted engine sound amplitude level for an improved driver experience.

It is known to provide a flexible diaphragm in the sound transmission tube to provide air flow isolation, thereby preventing air flow through the sound transmission tube. Even if the sound tube is not extended into the passenger compartment, it is undesirable to permit air flow back into the engine air intake tract through a sound transmission tube for which the purpose is strictly to conduct sound. This is especially undesirable if the sound tube is connected to the clean side of the air filter as any air flow through the tube would be introduced as unfiltered air into the air intake tract.

It is known to provide tuning of a transmitted sound spectrum in a vehicle sound transmission device by the addition of a quarter wave tuner or a resonator chamber in the sound transmission tubing. A quarter wave tuner is a useful to attenuate or cancel a selected transmitted sound frequency. The quarter wave tuner may be positioned and connected to the sound transmission tubing so as to extend outwards from the tubing in a branch configuration, typically (although not necessarily) at about 90 degrees relative to the axis of the sound transmission tubing. Alternately, when it is desired to amplify a selected transmitted sound frequency then an inline resonator chamber may be provided in the sound transmission tubing. If the inline resonator is configured with a duct length L, then the amplified sound wavelength will be a function of L/2. The use of quarter wave tuners and inline resonators, alone or in combination, permit the transmitted sound to be tailored using only passive devices rather than by the application of more expensive and complicated active electronic devices.

U.S. patent application Ser. No. 12/061703 discloses a device for noise transmission in a motor vehicle. In this device sound is transmitted along a transmission line having an enlarged mouth at one end and a diaphragm fitted to close off the mouth. A protective device is fitted at the end to protect the diaphragm.

U.S. Pat. No. 6,600,408 B1 discloses a device for sound transmission for a motor vehicle. In this device, the sound is transmitted along a pipe conduit and a chamber in which a diaphragm is arranged toward the interior of the motor vehicle. The chamber that surrounds the diaphragm is comprised of several assembled parts.

German patent publication DE 101 16 169 A1 discloses a resonator chamber in which the diaphragm is arranged.

German patent DE 44 35 296 discloses a diaphragm for noise transmission in a motor vehicle in which the diaphragm is clamped in a holder.

U.S. published patent application 2006/0283658 A1 discloses a system for noise increase of an intake system of a motor vehicle. Various possibilities of noise introduction into the interior of the motor vehicle are illustrated wherein the diaphragm is arranged in a pipe conduit for noise transmission.

In the German publication DE 199 30 025 A1 a sound transmission body is illustrated in which the diaphragm is clamped between two transmission members.

### SUMMARY OF THE INVENTION

A sound transmission device according to prior art may have a sound transmission tube that includes a flexible membrane or diaphragm covering an end of the tube or dividing the tube into two portions. A sound transmission device so configured is a passive device that can be tuned by changing the length of the interconnecting duct, by adding resonator chambers. In the present invention the membrane is selectively tuned by the addition of ribbing and/or a dampening member configured to selectively stiffen portions of the membrane to attenuate undesired sound frequency components.

Advantageously, the present invention results in improved tuning of the engine sound transmitted to the vehicle interior and results in improved material savings when compared to adding other countermeasures such as a quarter wave tuner or a side branch resonator.

In one aspect of the invention, a sound transmission device for transmitting an engine rumble sound into an interior of a motor vehicle while attenuating at least one undesired sound frequency includes a transmission line in acoustic communication with an air intake tract of the engine. A flexible membrane is arranged at and closing off an opposing second end of the transmission line, the membrane is tensioned to tune the transmitted sound spectrum. The membrane is provided with one or more countermeasures shaped, configured and secured to the membrane to attenuate transmission of one or more undesired frequencies by limiting flexure of a portion of the membrane at the undesired frequencies. The sound transmission device has a length selected to tune the sound transmission device to a desired target transmission frequency.

In another aspect of the invention, the sound transmission device includes a broadcast duct having a mouth at a first end. The mouth is sized and configured to close off against a side of the membrane in an air-tight fashion. The duct is arranged to transmit the engine rumble sound towards the interior of the motor vehicle.

In another aspect of the invention, the broadcast duct extends into the vehicle interior to deliver the engine rumble sound therein.

In another aspect of the invention, the countermeasures include at least one radially arranged rib secured to and extending across portions of the sound transmitting portion of the membrane.

In another aspect of the invention, the countermeasures include a dampening member secured to the membrane and having a position on the membrane as well as a size selected to restrict flexure of portions of the membrane responsive to the undesired frequencies.

In another aspect of the invention, at least a portion of the ribs have an end joined to and tensibly connected to the dampening member. The ribs cooperate with the dampening member to substantially attenuate the undesired frequencies.

In another aspect of the invention, a sound transmission device has a sound spectrum for transmitting an engine rumble sound into an interior of a motor vehicle while attenuating at least one undesired sound frequency includes a lower trumpet having at a first end a mouth portion and an opposing end in air tight connection with a second end of the transmission line. The lower trumpet includes a circumferential flange arranged at the mouth portion and extending radially outwards therefrom. The flexible membrane is secured to the mouth portion and tensioned to close off the mouth portion. The membrane having one or more countermeasures shaped, configured and secured to the membrane to attenuate transmission of one or more undesired sound frequencies by limiting flexure of a portion of the membrane according to a predicted modal shape of the membrane at the undesired frequencies. An upper trumpet includes a circumferential flange sized and configured to closeable mate with the flange of the lower trumpet.

In another aspect of the invention, a method of transmitting a desired engine rumble sound spectrum into an interior of a motor vehicle while attenuating at least one undesired sound frequency in the spectrum is disclosed. The method includes the steps of providing a transmission line having a first end and a second end, wherein the first end is in air tight acoustic communication with an air intake tract of the engine. Positioning and tensioning a flexible membrane having a sound transmitting portion to close off an opposing second end of the transmission line. Determining and establishing the membrane tensioning to tune the sound spectrum. Determining undesired frequency components of the tuned sound spectrum. Determining regions of the membrane responsive to the undesired frequencies to be damped. Providing and configuring a dampening member to selectively dampen the responsive membrane regions, the dampening member secured to the membrane. Providing at least one rib on the membrane, the ribs having an end joined to the dampening member and cooperating with the dampening member to attenuate the undesired frequencies.

In another aspect of the invention, the method includes determining or calculating a required length of the transmission line to establish a target engine sound transmission frequency Tf.

In the present invention, the diaphragm is tuned to remove or attenuate a desired sound frequency by adding countermeasures such as ribbing onto the membrane to eliminate specific membrane mode shapes.

### BRIEF DESCRIPTION OF THE DRAWINGS

The accompanying Figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

Features of the present invention, which are believed to be novel, are set forth in the drawings and more particularly in the appended claims. The invention, together with the further objects and advantages thereof, may be best understood with reference to the following description, taken in conjunction with the accompanying drawings. The drawings show a form of the invention that is presently preferred; however, the invention is not limited to the precise arrangement shown in the drawings.

FIG. 1 schematically depicts a sound transmission device connected into the engine air intake tract of a motor vehicle and transmitting sound into the interior of the motor vehicle, consistent with the present invention;

FIG. 2 is a sectional side view of a sound transmission device having an upper and lower trumpet assembly with a sound transmitting membrane, consistent with the present invention;

FIG. 3 is a graph illustrating sound transmission loss of a standard membrane in a sound transmission device, illustrating the target frequency response and an undesired frequency component at Tu;

FIG. 4A is a membrane mode shape plot of a membrane driven by a sound pressure wave at a sound transmission device frequency Tu of an undesired frequency to be attenuated;

FIG. 4B is a section view taken along 4B-4B of FIG. 4A.

FIG. 4C is a perspective view of a sound transmission membrane equipped with countermeasures to attenuate transmission of one or more undesired sound frequencies, consistent with one aspect of the present invention; and

FIG. 5 is a graph illustrating a sound transmission loss of a membrane incorporating countermeasures compared to the same membrane without the countermeasures, consistent with the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in apparatus and methods relating to devices for transmitted engine rumble sounds into a vehicle interior that include countermeasures to remove or substantially attenuate undesired frequency components from the transmitted sound spectrum. Accordingly, the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

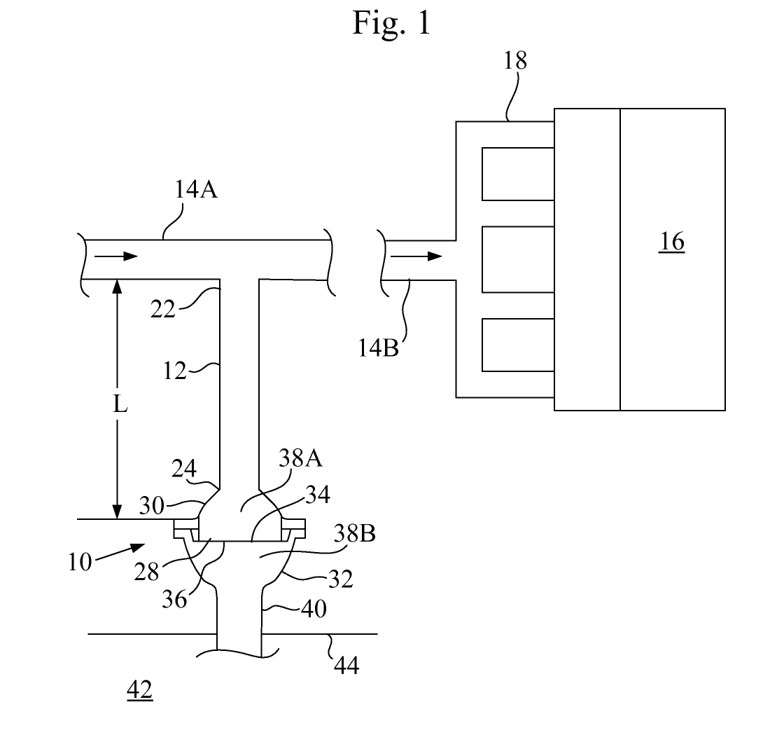

FIG. 1 schematically depicts a sound transmission device 10 having a first transmission line 12 connected at one end 14 to an air intake tract 14A of an internal combustion engine 16. Air intake tract portions 14A and 14B may have interposed there-between additional components such as a throttle body (not shown) or possibly an air filter or air cleaner (not shown). For better sound performance, preferably the first transmission line connects to the air intake tract 14A in a location downstream of the air filter (not shown) so that in FIG. 1 (for this case) the air cleaner would be positioned upstream (relative to air flow) of the air intake tract 14A portion illustrated (air flow direction illustrated by arrow 62).

The opposing end 24 of the first transmission line 12 is in airtight connection with a lower trumpet 26. A flexible membrane 28 is secured and tensioned to close off the trumpet rim 30 at a first side 34 of the flexible membrane 28. An upper trumpet 32 in configured and adapted to seal against an opposing second side 36 of the flexible membrane 28. The trumpets 26 and 32 define cavities 38A and 38B in which the flexible membrane 28 is free to deflect in response to acoustic pressure pulsations transmitted along first transmission line 12 from the engine 16.

The upper trumpet 32 may connect to a broadcast duct 40 that may in some aspects extend into the passenger compartment 42 through the firewall 44. In other aspects of the invention the broadcast may terminate inside the engine compartment and proximate to the firewall 44. In still other aspects of the invention, the broadcast duct may be omitted and the diaphragm 28 instead positioned to radiate sound within the engine compartment towards the interior 42 of the motor vehicle. In additional aspects of the invention, the trumpet 26 and 32 may be omitted and the sound transmitting membrane closes over the end 24 of the transmission line 12. The end 24 of the transmission line 12 may be of larger diameter than the transmission line 12 so as to form an enlarged diameter mouth over which the membrane 28 is closeably tensioned. In further aspects of the invention the transmission line 12 and the lower trumpet 26 may be formed as a unitary component by a plastic molding process such as injection molding. Similarly, in additional aspects of the invention the upper trumpet 32 and broadcast duct 40 may be formed as a unitary component by a plastic molding process such as injection molding. Components may be configured and arranged in other ways utilizing the principles taught in the present disclosure without deviating from the inventive concepts and present invention disclosed herein.

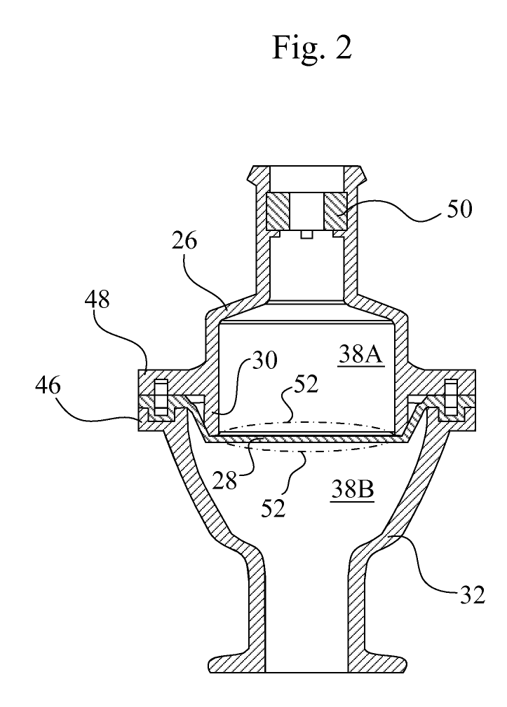

In accordance with at least one aspect of the present invention, FIG. 2 depicts a sectional side view of the lower trumpet 26 having the flexible membrane 28 tensioned on and closing over the rim 30 of the lower trumpet 26. The upper trumpet 46 is provided with flanges configured to compressively and sealably engage peripheral portions of the membrane 28 against the flanges 48 of the lower trumpet 26, tensioning the membrane 28 onto and over the rim 30 of the lower trumpet 26. The membrane 28 provides an air tight separation between the cavities 38A and 38B and may be tensioned to tune the transmitted sound spectrum.

In some aspects of the present invention throttles 50 may be provided at either the lower or upper trumpet. Throttles 50 further restrict acoustic air pressure pulsations through sound transmission device 10 and are operable to further tune the transmitted sound spectrum. Acoustic pressure pulsations in the air intake tract are communicated by the first transmission line 12 to into the cavity 38A where they act to sympathetically displace or flex the membrane 28. Flexure of the membrane 28 re-transmits acoustic pressure pulsations into the otherwise isolated cavity 38B where they may then be transmitted to the driver and passengers of the vehicle interior 42 through the broadcast duct 40.

Advantageously, in the present invention the membrane 28 may be provided with countermeasure features of the present invention. Countermeasure features may be provided, secured onto or formed with the membrane and configured such that sound amplitude vs. frequency spectrum of the pressure pulsations in cavity 38B (as experienced by the driver/passengers in vehicle interior 42) deviates in intentional and advantageous ways from the sound amplitude vs. frequency spectrum of the pressure pulsations in the cavity 38A. This is discussed in more detail below.

Depending on the application, for obtaining the corresponding mechanical properties, the flexible membrane 28 may be made of rubber film, fabric or plastic film or may also be a metal foil or a thin sheet metal. In a preferred embodiment in the present invention, the diaphragm 28 is comprised of a rubber material, for example, ethylene propylene diene rubber (EPDM), silicon rubber (VMQ), fluorosilicone rubber (FVMQ), fluoropolymer rubber (FPM or FKM) or other suitable flexible materials as are known to those skilled in the art.

Particularly for elastic diaphragm materials such as varieties of rubber, the height of the rim 30 relative to the flange 48 may be configured to result in a specific desired (intentional) tension in the membrane 28. The tension in the membrane 28 may be selected to tune the acoustic flexure properties of the membrane 28 and therefore is one means of adjusting how the sound amplitude vs. frequency spectrum in cavity 38B may intentionally deviate from the sound amplitude vs. frequency spectrum in cavity 38A.

Another way in which the acoustic flexure properties of the membrane 28 may be tuned or adjusted is by varying the thickness (and therefore mass and stiffness) of the membrane 28, thereby tuning how the sound amplitude vs. frequency spectrum in cavity 38B may intentionally deviate from the sound amplitude vs. frequency spectrum in cavity 38A in advantageous and desirable ways. Additionally the acoustic flexure properties of the membrane 28 may be modified by using different membrane materials having different properties, a few examples include elasticity, mass, and stiffness.

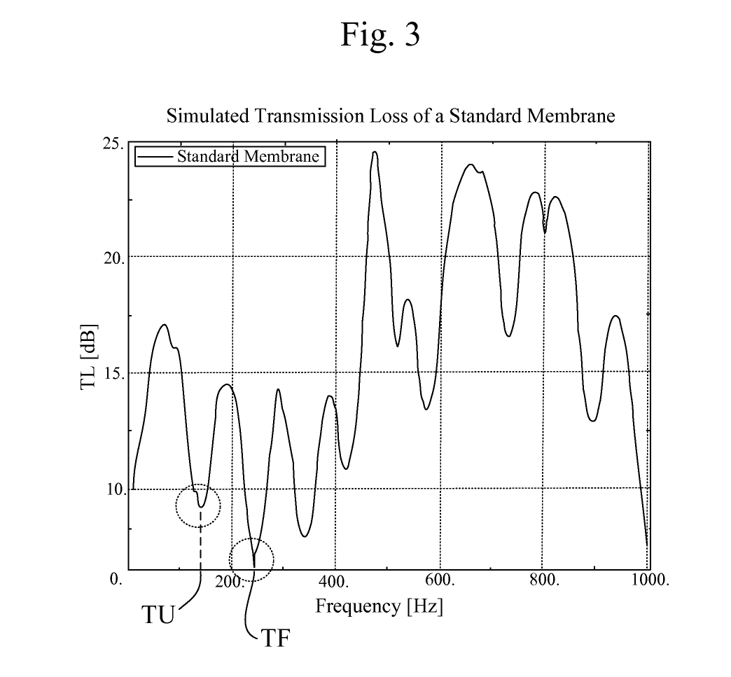

FIG. 3 is a graph illustrating a sound transmission loss spectrum of a particular measured standard membrane (for example, 28) wherein the transmission loss TL in decibels is presented on the vertical axis as a function of the sound frequency (Hertz) shown along the horizontal axis. A desired target frequency Tf for the sound transmission device 10 is known to the designer and is typically a frequency at which the desired engine sound (for example a sporty engine rumble sound) is best experienced by a vehicle driver or passenger. The tuned target frequency Tf of the sound transmission device 10 is a function of the overall length L of the sound transmission device 10 and is therefore tunable by intelligent selection of the overall length L (for example when L is ½ the wavelength of the target frequency Tf, the received and reflected sound waves interfere in additive ways to minimize the transmission loss of the transmitted sound at Tf, as is known to those skilled in the art). At Tf the minimum transmission loss occurs through the sound transmission device 10, which in FIG. 3 may be engineered to occur at a desired target frequency of about 240 Hz (for example), which (in this example) is a frequency providing a desirable engine rumble sound to the driver. In FIG. 3, as frequency is varied, the closer the plotted curve is to the horizontal axis the less attenuated is the corresponding frequency (horizontal axis) transmitted by the sound transmission device 10.

Located to the left of Tf is (for an illustratory example herein) an undesired transmitted frequency Tu of 140 Hz (as an example for discussion herein) with a relatively low loss (on the graph). It is desirable to remove certain transmitted sound frequency components which detract from the clean engine rumble sound desired by the driver, such as those relatively prominent components about or near frequency Tu. Therefore, a solution is desirable to remove or at least significantly attenuate the transmission of sound components around Tu (specific frequency selected here only to provide an illustratory example for discussion).

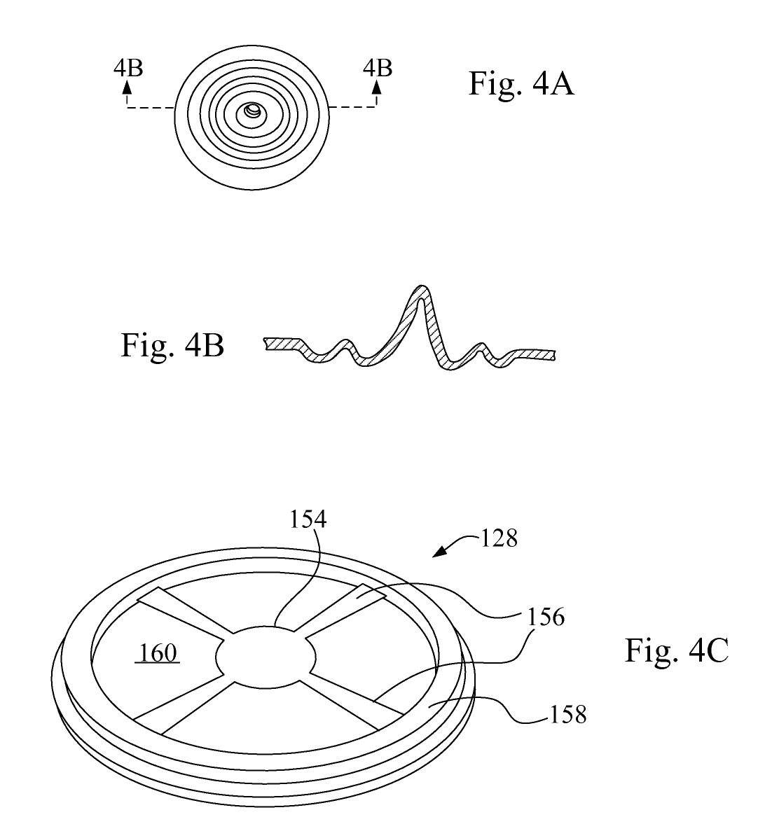

According to the present invention, countermeasure ribs may be advantageously configured and incorporated with, formed onto or secured onto the membrane to create a ribbed membrane 128 (see FIG. 4B). FIG. 4A depicts a simulated membrane mode shape plot at an excitation frequency of Tu. FIG. 4B presents a sectional view taken along 4B-4B of FIG. 4A. It may be determined (either through experimentation, by simulation using of a finite element model or computational fluid dynamic simulation (as known to those skilled in the art) to determine membrane mode shapes at the specific undesired frequency or frequencies, such as Tu) that a specific central region of the diaphragm 128 needs to be further constrained so as to limit flexure or displacement in that region and thereby attenuate transmission of frequency components around Tu. For example, the membrane modes shape (FIGS. 4A, 4B) may be obtained by computational simulation, such as FEA or CFD analysis. From such analysis, it may be determined that reducing the displacement of the membrane in a center would advantageously increase the transmission loss in the membrane at undesired frequency Tu. To this end, in FIG. 4C a generally circular dampening member 154 is provided, secured onto, formed with or integrated with the center of the membrane 128. Ribs 156 (in the illustrated example four ribs) were also secured onto, formed with or integrated with the membrane 128 and circular member 154 to provide the illustrated ribbed membrane 128 of FIG. 4B. The ribs 156 extend across the flexure central area (sound transmission portion 160) of the membrane 128 and additionally may be connected to the mounting portion (in FIG. 4B mounting rim 158) of the membrane 128. The ribs 156 and circular member 154 reduce the displacement of the center portion of the membrane 128. In FIG. 4C the ribs 156 are arranged radially across the sound transmitting portion 160 (the portion of the membrane interior to the mounting rim 158). The dampening member 154 has a size (in FIG. 4C a diameter D) selected to restrain flexure of the membrane portion, particularly the membrane portion responsive to undesired frequencies to be attenuated.

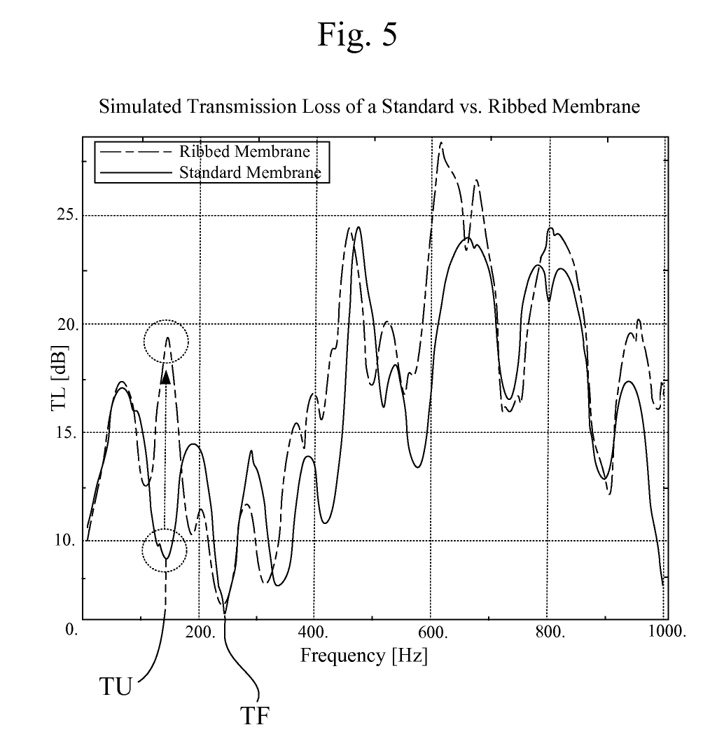

FIG. 5 provides a graph illustrating sound transmission loss spectrum of the standard (non ribbed) membrane (for example, 28) together with a sound transmission loss spectrum plot of the ribbed membrane 128 having engineered countermeasures as discussed immediately above. As in FIG. 5 the transmission loss TL in decibels is presented on the vertical axis as a function of the sound frequency in Hertz shown on the horizontal axis. As before, target frequency Tf is a function of the overall length of the sound transmission device 10 and is therefore tunable by intelligent selection of the overall length L (see FIG. 1). At Tf the minimum transmission loss occurs through the sound transmission device 10, which in FIG. 3 is engineered to occur at about 240 Hz (for example) as (in this example) this frequency provides a desirable engine rumble sound to the driver. As can been seen in FIG. 5, the ribbed membrane 128 provided with the engineered countermeasures of the present invention advantageously continues to achieve the desired loss low (low value of transmission loss TL at Tf and along other portions of the transmitted frequency spectrum) while further providing the desired significant attenuation of the transmitted sound at the undesired frequency Tu.

Advantageously, the present invention enables the transmitted sound of a sound transmission device 10 to be tailored to produce a cleaner engine or engine rumble sound to the driver by intelligent addition of reinforcement countermeasures to the membrane.

The membrane countermeasures are not limited to the ribbing pattern disclosed herein. Any form and pattern of selective ribbing and reinforcement may be applied to attenuate the membrane mode shapes at specific undesired frequencies without deviating from the inventive principles of the present invention. Selective ribbing and reinforcement countermeasures may be determined directly by simulation (such as FEA or CFD) or through experimentation (trial and error).

Advantageously, specific frequencies may be selectively attenuated without the addition of a side branch resonator (SBR) as is typically applied in the prior art. With a side branch resonator a resonator volume of up to 1 liter is typically required, thereby increasing material requirement, requiring additional under-the-hood mounting space, and increasing total sound transmission device cost. Therefore, significant cost and material savings occur through the use of the membrane countermeasures as taught in the sound transmission device of the present invention.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A sound transmission device having a sound spectrum for transmitting an engine rumble sound into an interior of a motor vehicle while attenuating at least one undesired sound frequency, comprising:
a transmission line having a first end and a second end, wherein said first end is in acoustic communication with an air intake tract of an engine;
a flexible membrane having a flexing sound transmitting portion and a mounting portion, said membrane arranged at and having a first side closing off said second end of said transmission line, said membrane tensioned to tune said sound spectrum, said membrane including:
one or more countermeasures shaped, configured and secured to said membrane to attenuate transmission of one or more undesired frequencies by limiting flexure of a portion of said membrane at said undesired frequencies;
wherein said sound transmission device has a length selected to tune said sound transmission device to a desired target frequency;
wherein said countermeasures include at least one radially arranged rib secured to and overlaying a flexing sound transmitting portion of said membrane.

2. The sound transmission device of claim 1, further comprising a broadcast duct having a mouth at a first end, said mouth sized and configured to close against an opposing second side of said membrane, said duct arranged to transmit said engine rumble sound towards said interior of said motor vehicle.

3. The sound transmission device of claim 3, wherein said broadcast duct extends into said vehicle interior to deliver said engine rumble sound therein.

4. The sound transmission device of claim 1, wherein said countermeasures include at least one radially arranged rib secured to and extending across portions of said sound transmitting portion of said membrane.

5. The sound transmission device of claim 1, wherein said countermeasures include at least one dampening member secured to said membrane, having a position on said membrane and a size selected to restrict flexure of portions of said membrane responsive to said undesired frequencies.

6. The sound transmission device of claim 4, wherein
said countermeasures include a dampening member secured to said membrane, having a position on said membrane and a size selected to restrict flexure of portions of said membrane responsive to said undesired frequencies;
wherein said at least a portion of said ribs have an end joined to said dampening member, said ribs cooperating with said dampening member to substantially attenuate said undesired frequencies.

7. The sound transmission device of claim 1, wherein said countermeasures are shaped and configured according to a predicted modal shape of said membrane at said undesired frequencies.

8. A sound transmission device having a sound spectrum for transmitting an engine rumble sound into an interior of a motor vehicle while attenuating at least one undesired sound frequency, comprising:
a transmission line having a first end and a second end, wherein said first end is in air tight acoustic communication with an air intake tract of said engine;
a lower trumpet having at a first end a mouth portion and at an opposing end in air tight connection with said second end of said transmission line, said lower trumpet having a circumferential flange arranged at said mouth portion and extending radially outwards therefrom;
a flexible membrane arranged at said mouth portion and tensioned to close off said mouth portion, said membrane having
one or more countermeasures shaped, configured, secured to and overlaying a sound transmitting flexing portion of said membrane, said countermeasures tuning said membrane, said tuning limiting flexure of said membrane at said undesired frequencies attenuating transmission of one or more undesired sound frequencies; and
an upper trumpet having a circumferential flange sized and configured to closeably mate with said flange of said lower trumpet;
wherein said sound transmission device has an overall length selected to tune said sound transmission device to a desired target frequency of said sound spectrum.

9. The sound transmission device of claim 8 further including:
a broadcast duct arranged to transmit said engine rumble sound towards said interior of said motor vehicle, said broadcast duct having
a first end closeably and acoustically coupled to said upper trumpet; and
a second end positioned to direct said engine rumble sound into said motor vehicle interior.

10. The sound transmission device of claim 9, wherein said second end of said broadcast duct extends into said vehicle interior to deliver said engine rumble sound therein.

11. The sound transmission device of claim 8, wherein said countermeasures include at least one radially arranged rib secured to and extending across portions of said sound transmitting portion of said membrane.

12. The sound transmission device of claim 8, wherein said countermeasures include at least one dampening member secured to said membrane, having a position on said membrane and a size selected to restrict flexure of portions of said membrane responsive to said undesired frequencies.

13. The sound transmission device of claim 11, wherein
said countermeasures include a dampening member secured to said membrane having a position on said membrane and a size selected to restrict flexure of portions of said membrane responsive to said undesired frequencies;
wherein said at least a portion of said ribs have an end joined to said dampening member, said ribs cooperating with said dampening member to attenuate said undesired frequencies.

14. The sound transmission device of claim 8, wherein said countermeasures are shaped and configured according to a predicted modal shape of said membrane at said undesired frequencies.

15. A method of transmitting a desired engine rumble sound spectrum into an interior of a motor vehicle while attenuating at least one undesired sound frequency in said spectrum, comprising:
providing a transmission line having a first end and a second end, wherein said first end is in air tight acoustic communication with an air intake tract of said engine;
positioning and tensioning a flexible membrane having a flexing sound transmitting portion to close off said second end of said transmission line;
establishing said membrane tensioning to tune said sound spectrum;
determining undesired frequency components of said tuned sound spectrum;
determining regions of said membrane responsive to said undesired frequencies to be damped;
providing and configuring a dampening member to selectively dampen said responsive membrane regions;
overlaying and securing said dampening member onto said responsive membrane regions of said membrane;
providing at least one rib overlaying and secured onto said membrane, said ribs having an end joined to said dampening member, said ribs cooperating with said dampening member to attenuate said undesired frequencies;
dampening said responsive membrane regions at said undesired frequencies by said dampening member and said ribs.

16. The method of claim 15, wherein prior to the providing a transmission line step, the method further includes:
determining a required length of said transmission line to establish a target engine sound transmission frequency Tf.
